(19) United States
(12) Patent Application Publication
(10) Pub. No.: US 2026/0320950 A1
(43) Pub. Date: Oct. 15, 2026

(54) IMAGING APPARATUS, CONTROL METHOD, STORAGE MEDIUM, IMAGE GENERATION UNIT, AND SYSTEM

(71) Applicant: CANON KABUSHIKI KAISHA, Tokyo (JP)

(72) Inventor: KENZO HISA, Tokyo (JP)

(21) Appl. No.: 19/637,671

(22) Filed: Apr. 2, 2026

(30) Foreign Application Priority Data
Apr. 9, 2025 (JP) 2025-064311

(51) Int. Cl. G06T 19/20; H04N 23/62; H04N 23/695

(52) U.S. Cl. CPC G06T 19/20; G06T 2200/24; G06T 2219/2004; H04N 23/62; H04N 23/695

(57) ABSTRACT

An imaging apparatus including an imaging unit configured to image a subject includes a reception unit configured to receive an operation regarding imaging in a virtual space, and a transmission unit configured to transmit information about the operation regarding the imaging by the imaging apparatus in the virtual space to a processing processor configured to generate an image of the virtual space and output an image captured in the virtual space to a display.

### BACKGROUND

### Field of the Technology

The present disclosure relates to an imaging apparatus, a control method, a storage medium, an image generation unit, and a system.

### Description of the Related Art

It is known that an avatar (an icon representing a user) are used in virtual space communication systems such as the metaverse. These avatars are presented in a virtual space using three-dimensional (3D) graphics. The user can then participate in various activities such as communicating with another avatar (another user) in the virtual space via this avatar. For this kind of virtual space communication system, various techniques have been developed which achieve an interaction linked to the real world so as to allow the user to truly feel an experience acquired through the operation of the avatar as the user's own action.

Specific examples include shopping in the virtual space and having an actual product delivered, and being able to acquire an image that is a result of imaging using an imaging apparatus. Regarding imaging using an imaging apparatus, Japanese Patent Laid-Open No. 2013-243754 proposes a method for imaging the virtual space using a real camera as a technique for further linking the virtual space to the real world. When a user holds the camera in the real world, a video image of the virtual space is displayed, and the user can capture an image in the virtual space.

When the real-world imaging apparatus is used in the virtual space, there are unused functions in the real space, such as largely moving the avatar or the imaging apparatus and switching a subjective video image from the avatar's point of view to an overhead view including the avatar.

### SUMMARY

The present disclosure has been made in consideration of the above-described issue, and is directed to providing an imaging apparatus that allows a user to perform an operation specific to a virtual space easily and simply when capturing an image in the virtual space.

According to an aspect of the present disclosure, an imaging apparatus includes an image sensor that captures an image of a subject, a memory storing instructions, and one or more processors that, upon execution of the stored instructions, configure the one or more processors to receive an instruction from a user regarding imaging in a virtual space, and transmit the instruction from the user regarding the imaging by the imaging apparatus in the virtual space to an image generation unit configured to generate an image of the virtual space and output an image captured in the virtual space to a display.

Features of the present disclosure will become apparent from the following description of embodiments with reference to the attached drawings. The following description of embodiments is described by way of example.

### BRIEF DESCRIPTION OF THE DRAWINGS

FIG. 1 illustrates a configuration of a system for image processing according to a first embodiment.

FIG. 2 illustrates a flow of selecting the usage of a real camera according to the first embodiment.

FIG. 3 illustrates an example of a virtual space according to the first embodiment.

FIG. 4 illustrates an outer appearance of a digital camera according to the first embodiment.

FIG. 5 illustrates a flow of moving the position of a virtual camera according to the first embodiment.

FIG. 6 illustrates an example of an angle of view before a movement in imaging by the camera in the virtual space according to the first embodiment.

FIG. 7 illustrates an example of an angle of view after the movement in the imaging by the camera in the virtual space according to the first embodiment.

FIG. 8 illustrates a flow of moving the position of the virtual camera according to a second embodiment.

FIG. 9 illustrates a flow of selecting whether to link tilts of a real camera and the virtual camera according to the second embodiment.

### DESCRIPTION OF THE EMBODIMENTS

In the following description, embodiments will be described in detail with reference to the attached drawings.

### First Embodiment

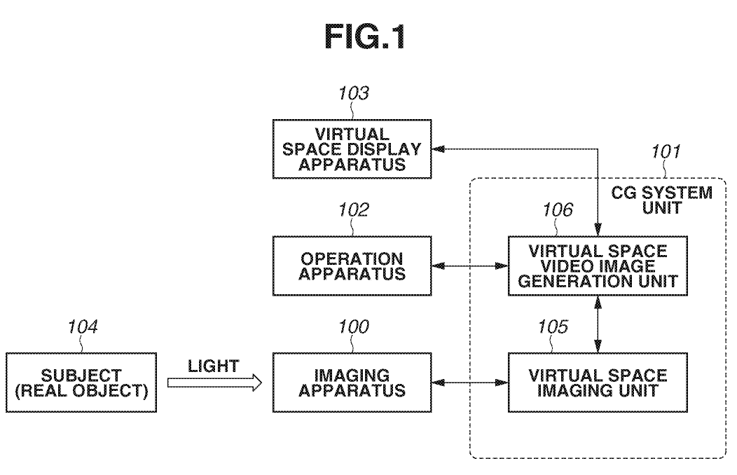

FIG. 1 illustrates a system configuration of an image processing according to the present embodiment. The embodiment of the present disclosure is mainly divided into four apparatus configurations. The first apparatus configuration is an imaging apparatus 100, which can be operated to capture an image in the real world and capture an image in a virtual space. The second apparatus configuration is a computer graphics (CG) system unit 101, which generates a virtual space video image by three-dimensional CG. The third apparatus configuration is an operation apparatus 102, which allows a user to issue an operation instruction in the virtual space. The fourth apparatus configuration is a virtual space display apparatus 103, which allows the user to monitor inside the virtual space.

These imaging apparatus 100, CG system unit 101, operation apparatus 102, and virtual space display apparatus 103 are connected via a communication interface enabling high-speed processing to communicate video information in real time.

The present embodiment will be described citing an example in which the same camera as the imaging apparatus 100 is displayed in the virtual space (hereinafter referred to as a virtual camera), and an operation of tilting the imaging apparatus 100 or moving the position thereof causes the virtual camera to also operate similarly. An object different from the imaging apparatus 100 may be displayed in the virtual space as the virtual camera. Further, the following embodiment will be described as being implemented using a digital camera as an example of an imaging apparatus having an imaging function. However, without being limited thereto, examples of the imaging apparatus include a computer apparatus (a personal computer, a tablet computer, a media player, a personal digital assistant (PDA), and the like), a cellular phone, a smartphone, a gaming device, a robot, and a drone. They are merely examples, and the present disclosure can also be implemented for another imaging apparatus. Further, types of the video image are not especially limited in terms of an analog type or a digital type, specifications and standards of a data signal type, compression/decompression, and the like, a recording device and a recording medium, a recording time, and the like, and any type can be used according to the intended purpose as appropriate. Further, any type can also be used as the camera apparatus main body, the imaging method, and the like as appropriate.

In imaging in the real space, the imaging apparatus 100 can capture a moving image or a still image.

On the other hand, in imaging in the virtual space, a user captures a moving image or a still image in the virtual space by using the imaging apparatus 100 with an action as if capturing the image in the real space while viewing a video image of the virtual space on the virtual space display apparatus 103. Further, in the time of imaging in the virtual space, a function necessary for imaging in the virtual space is enabled, thereby allowing the user to capture an image using only the imaging apparatus 100 without using the operation apparatus 102.

### Configuration of Imaging Apparatus

The imaging apparatus 100 illustrated in FIG. 1 can image a subject 104 according to an instruction issued by the user in imaging in the real space. The imaging apparatus 100 includes a lens unit supporting focusing and zooming control, an image sensor such as a complementary metal-oxide semiconductor (CMOS) sensor, and a neutral density (ND) filter and a diaphragm for adjusting exposure. Further, the imaging apparatus 100 is a digital camera (hereinafter referred to as a real camera) equipped with a known control system of, for example, a shutter speed and a gain for adjusting brightness of a video image, and white balance (WB) for adjusting a color tone.

On the other hand, in imaging in the virtual space, control data such as the position, the tilt, and the settings of the imaging apparatus 100 is transmitted to the CG system unit 101, which will be described below. At this time, the real camera does not perform lens control, imaging, image processing, and recording.

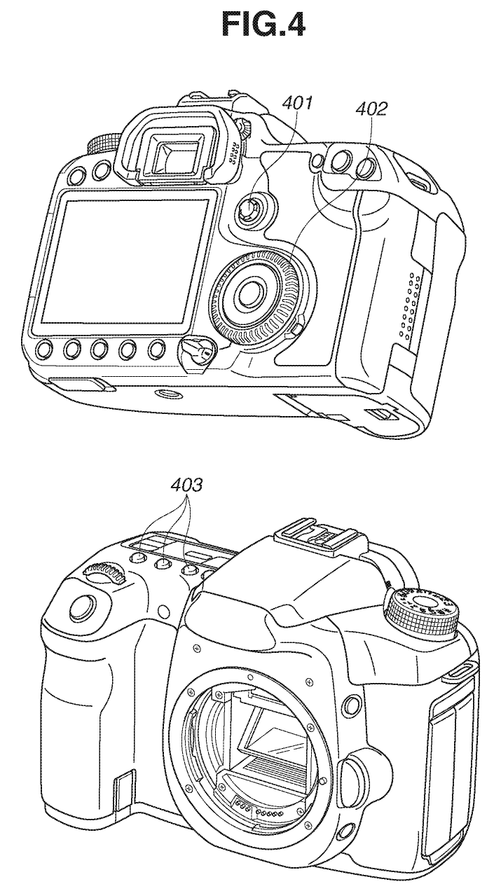

FIG. 4 illustrates the outer appearance of the digital camera. Assume that the digital camera held by a user in the real space and a virtual camera held by an avatar are the same.

### Configuration of CG system Unit

Next, the CG system unit 101 surrounded by a dotted portion in FIG. 1 will be described. The CG system unit 101 includes a three-dimensional CG program and a computer equipped with a processing processor for executing the three-dimensional CG program. The CG system unit 101 has a function of creating a CG video image in real time using this three-dimensional CG program. A virtual space imaging unit 105 and a virtual space video image generation unit 106 provided in the CG system unit 101 are functional blocks whose functions are realized by this computer.

The virtual space imaging unit 105 acquires control data such as the position, the tilt, and the settings of the real camera. Information regarding the angle of view, such as the position and zoom information, and orientation information on the real camera in the acquired data is transmitted to the virtual space video image generation unit 106.

The virtual space video image generation unit 106 stores information about positions, orientations, colors, luminance, and the like of a virtual mountain, a virtual building, a virtual road, the camera, the avatar, and the like (hereinafter referred to as virtual space information) in advance. Further, the virtual space video image generation unit 106 also displays a screen to which the virtual space information is set. The virtual space information directly changes according to the control data of the imaging apparatus 100 or the operation apparatus 102, which will be described below. Further, the virtual space information can also be changed by operating the imaging apparatus 100 or the operation apparatus 102 to change the set screen. The virtual space video image generation unit 106 then processes, based on the virtual space information, a video image in a specific angle of view from a specific viewpoint into data displayable on the virtual space display apparatus 103, which will be described below and transmits the video image.

Further, the virtual space video image generation unit 106 also generates image data captured by the virtual camera. The virtual space video image generation unit 106 updates the virtual space information of the virtual camera according to the information regarding the angle of view that has been acquired from the virtual space imaging unit 105. The virtual space video image generation unit 106 generates unprocessed image data of a virtual subject in an angle of view according to information about the zoom position and the like in a virtual subject located in a direction where the virtual camera faces as viewed from the position of the virtual camera in the three-dimensional virtual space, based on the updated virtual space information. The unprocessed image data is transmitted from the virtual space video image generation unit 106 to the virtual space imaging unit 105, which will be described below. The virtual space imaging unit 105 generates processed image data by performing image processing on the acquired unprocessed image data, based on information regarding an image quality such as brightness and white balance in the control data acquired from the imaging apparatus 100. The processed image data is transmitted to the virtual space video image generation unit 106. The processed image data is combined with the virtual space according to the virtual space information. For example, the processed image data is combined as information displayed on a display unit (e.g., a liquid crystal display) of the virtual camera. The combined image data is displayed together with another nearby virtual subject, as long as this virtual subject is within a range displayed on the virtual space display apparatus 103. In a case where an instruction to record a still image has been acquired via the imaging apparatus 100 or the operation apparatus 102, the unprocessed or processed image data is stored into a storage device in the computer according to the settings. In a case of an instruction to start video recording, the image data starts to be stored into the storage device.

### Configuration of Operation Apparatus

The operation apparatus 102 is a remote controller, a keyboard, or the like for the user to experience the virtual space, and is used to, for example, change the position of the avatar or the angle of view in the virtual space, perform an operation for talking with another avatar, and change a setting of the virtual space. This is a known technique, and thus the detailed description thereof will be omitted.

### Configuration of Virtual Space Display Apparatus

The virtual space display apparatus 103 is a display for displaying a three-dimensional video image, such as a head-mounted display (hereinafter referred to as an HMD). Wearing the HMD over the head allows the user to view a virtual space video image generated by the CG system unit 101. The configuration of the virtual space display apparatus 103 is a known technique, and thus the detailed description thereof will be omitted. Displaying left and right images having parallax, which are generated by the virtual space video image generation unit 106, on the virtual space display apparatus 103 allows the user to view a three-dimensional video image. The user performs an operation of, for example, moving the avatar and the virtual camera, and changing the angle of view and the brightness by using the imaging apparatus 100 while checking the video image in the virtual space displayed on the virtual space display apparatus 103.

### Change Position of Virtual Camera in Virtual Space

Next, an example of changing the position of the virtual camera in the virtual space by using the digital camera as the imaging apparatus 100 will be described.

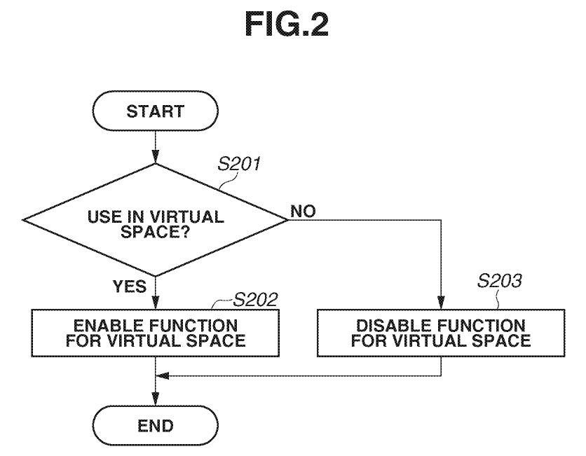

First, FIG. 2 illustrates a flow of selecting the usage of the real camera.

In FIG. 2, first, the user selects, in step S201, whether to use the digital camera in the virtual space. In this selection, for example, a choice of whether to use the digital camera in the virtual space is added to a menu of the digital camera, and the use in the virtual space is selected in the control system of the digital camera by receiving an instruction from the user. More specifically, "use in the virtual space" is displayed on the menu of the digital camera. When this choice is selected by the user, a screen for selecting "enablement" or "disablement" is output on the display unit of the digital camera. If the enablement is selected by the user (YES in step S201), the processing proceeds to step S202. In step S202, a function for the virtual space on the digital camera is enabled. If the disablement is selected by the user (NO in step S201), the processing proceeds to step S203. In step S203, the function for the virtual space is disabled. When the function is enabled, a function to be usable when the virtual space is imaged by the virtual camera although being unnecessary for the normal digital camera is enabled. When the use in the virtual space is "enabled" in the control system of the digital camera, the imaging apparatus 100 and the CG system unit 101 communicate instruction information acquired via a user input interface (e.g., an operation member) of the digital camera, thereby allowing the user to operate the digital camera in the virtual space.

This function may be changed to be "enabled" or "disabled" automatically without being selected by the user. For example, when the user is wearing the HMD and experiencing the virtual space, if the digital camera is powered on, the function for the virtual space may become enabled. Alternatively, when the digital camera is powered on, if the user puts on the HMD and starts experiencing the virtual space, the function for the virtual space may become enabled.

Next, the function for the virtual space will be described. In the real space, when changing the position of the camera, a human moves while holding the camera, but in the virtual space, the position of the virtual camera can also be moved with an operation. The position of the virtual camera is normally moved using the operation apparatus 102 such as a remote controller. However, it is inconvenient to switch to the remote controller when holding the digital camera, and thus the present embodiment allows the position of the virtual camera to be moved with an operation on the digital camera.

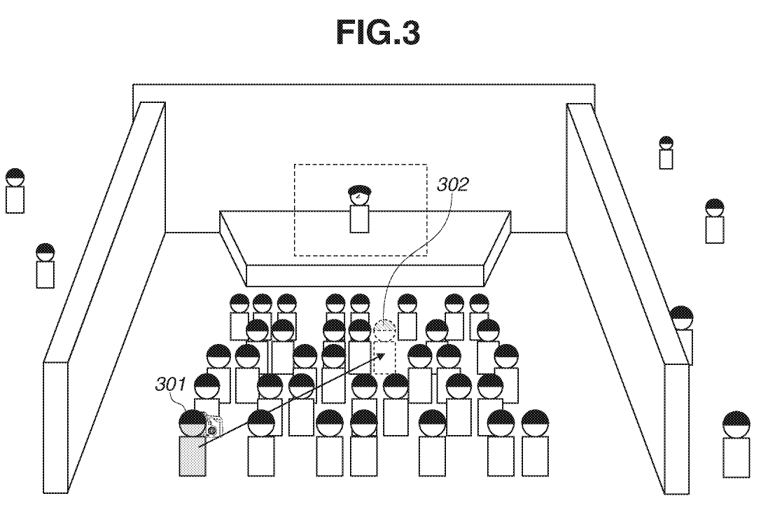

FIG. 3 illustrates an example of the virtual space. The user is represented by an avatar 301. Assume that the avatar holds the virtual camera and images the virtual space. Assume that the user wants to move to the position of an avatar 302 from a state of being located at a position of the avatar 301 to change the composition for imaging.

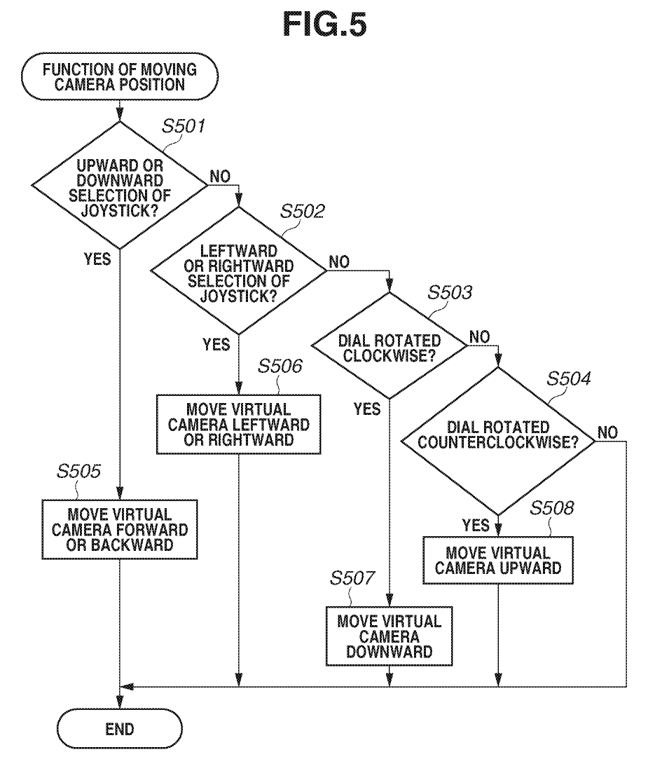

In light thereof, the movement of the position is achieved by a flow of moving the position of the virtual camera as illustrated in FIG. 5.

When the function for the virtual space of the imaging apparatus 100 is enabled, this allows the user to move the position of the virtual camera by using a joystick 401 and a dial 402. If the joystick 401 is tilted upward or downward (YES in step S501), the processing proceeds to step S505. In step S505, the avatar and the virtual camera move forward or backward. If the joystick 401 is tilted leftward or rightward (YES in step S502), the processing proceeds to step S506. In step S506, the avatar and the virtual camera move leftward or rightward. By using these operations to change the composition, the user can move the avatar and the virtual camera from the position of the avatar 301 to the position of the avatar 302. The dial 402 is used when the user wants to move the position of the virtual camera upward or downward, although this is unnecessary in the example illustrated in FIG. 3. If the dial 402 is rotated clockwise (YES in step S503), the processing proceeds to step S507. In step S507, the avatar and the virtual camera move downward. If the dial 402 is rotated counterclockwise (YES in step S504), the processing proceeds to step S508. In step S508, the avatar and the virtual camera move upward.

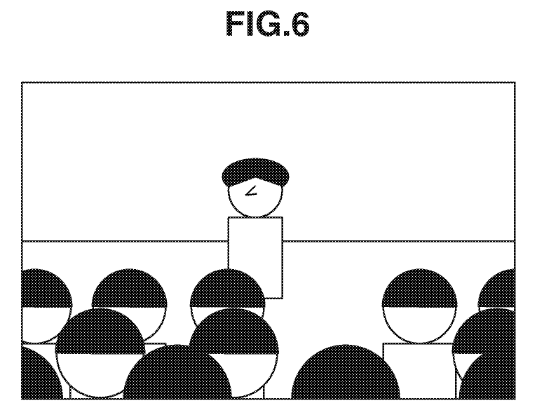

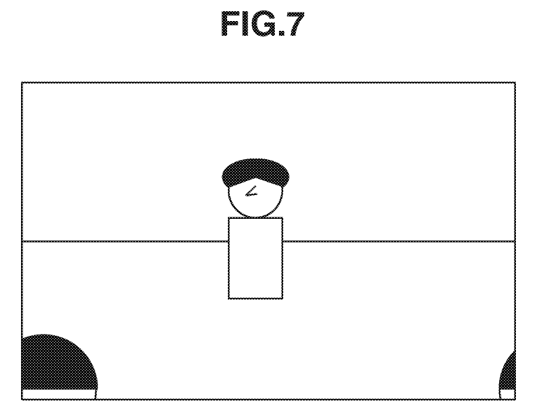

FIG. 6 illustrates an example of the angle of view before the movement in the imaging by the camera in the virtual image. FIG. 7 illustrates an example of the angle of view after the movement in the imaging by the camera in the virtual image. The reflection of another avatar different from the main subject has been eliminated.

The present embodiment has been described citing the example using the joystick 401 and the dial 402, but there is a possibility that the joystick 401 and the dial 402 are used for an operation of a function of the digital camera that is also used in the virtual space. Alternatively, even if the joystick 401 and the dial 402 are not used in the initial settings, the joystick 401 and the dial 402 may be used in a specific case, such as when a face is detected or a menu is opened. In such a case, one function among upward, downward, leftward, rightward, forward, and backward movements may be directly assigned to assignable buttons 403 to which a function can be assigned. Alternatively, a function of allowing a movement in the virtual space to be controlled with an operation of the joystick 401 or the dial 402 while an assignable button 403 is pressed may be assigned to the assignable button 403, thereby allowing a movement to be controlled without affecting another function.

After the avatar and the camera have been moved to a desired position as described above, the real camera is operated to determine the zoom and the angle of view and adjust the image quality such as the brightness and the white balance similarly to imaging in the real space. Thereafter, an image or a video image in the virtual space can be recorded by pressing the shutter button to capture a still image or pressing a recording (REC) button to record a moving image.

The present embodiment has been described citing the example of moving the avatar and the camera as the function enabled for the virtual space. Besides this, the display video image may be switched from a panoramic video image as illustrated in FIG. 3 to a video image captured by the virtual camera illustrated in FIGS. 6 or 7 (a video image from the avatar's point of view) as the function enabled for the virtual space, for example. Alternatively, a function of displaying and selecting a menu for the virtual space, or displaying and moving a pointer (an indicator) may be enabled.

Imaging using the real camera by the above-described method allows a user to capture a moving image and a still image with an operation similar to that in the real space using the real camera even in the virtual space. Moreover, even an operation specific to the virtual space that is useful at the time of imaging by the camera, such as moving the avatar or the camera or changing the viewpoint in the virtual space, can also be realized using the real camera without using the remote controller for the virtual space.

### Second Embodiment

The first embodiment has been described with respect to the example of moving the positions of the avatar and the virtual camera by using the joystick 401 and the dial 402. However, an operation of an operation member such as a button may make a user feel awkward. In light thereof, a second embodiment will be described in which an example of moving positions of an avatar and a virtual camera by using a tilt of a camera. At this time, the imaging apparatus 100 and the CG system unit 101 communicate tilt information of the digital camera similarly to the first embodiment, thereby allowing the user to operate the digital camera in the virtual space. In other words, an orientation detection sensor mounted on the real camera is used as a user input interface. If the user's action of intentionally tilting the apparatus is determined to be an "input", this user input interface receives the instruction of the user regarding imaging in the virtual space and generates an input signal corresponding to the instruction. Examples similar to the first embodiment are used as examples of the system configuration, the flow, the outer appearance of the digital camera, and the virtual space illustrated in FIGS. 1 to 7, and therefore the detailed descriptions will be omitted.

### Change Position of Virtual Camera in Virtual Space

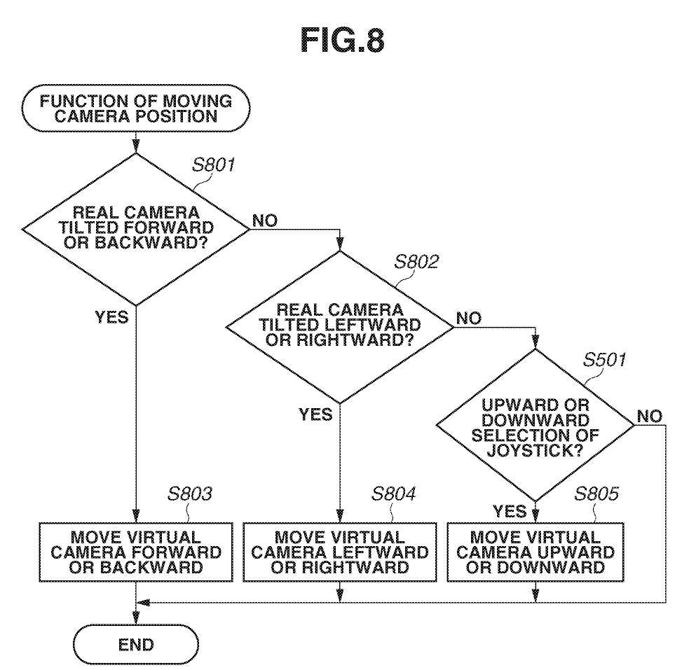

FIG. 8 illustrates a flow of moving the virtual camera according to the present embodiment. Enabling the function of the digital camera for the virtual space as in the first embodiment allows the user to move the positions of the avatar and the virtual camera according to the tilt of the real camera. When the real camera is tilted forward or backward (YES in step S801), tilt information of a gyroscope mounted on the real camera is transmitted to the virtual space imaging unit 105. The virtual space imaging unit 105 calculates a movement speed according to the angle of the tilt. The calculated movement speed is transmitted to the virtual space video image generation unit 106. In step S803, the virtual space video image generation unit 106 changes and displays the positions of the avatar and the virtual camera in the forward or backward direction based on the received movement speed. When the real camera is tilted leftward or rightward (YES in step S802), similar information is also transmitted, and the processing proceeds to step S804. In step S804, the virtual space video image generation unit 106 changes and displays the positions of the avatar and the virtual camera in the leftward or rightward direction. When the joystick 401 of the real camera is tilted upward or downward (YES in step S501), the processing proceeds to step S805. In step S805, the positions of the avatar and the virtual camera are moved vertically. In the first embodiment, the positions of the avatar and the virtual camera are moved vertically with the operation of the dial 402. However, the upward or downward tilt of the joystick 401 is used for the vertical movement because the upward and downward are not used for the forward and backward movements in the second embodiment. However, the operation triggering the vertical movement is not limited thereto. For example, the positions of the avatar and the virtual camera may be changed using the dial 402 as in the first embodiment, or may be moved by pressing the assignable buttons 403.

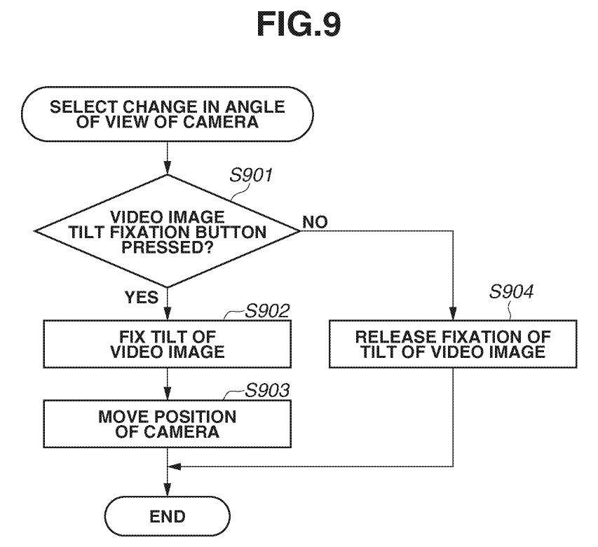

When the user wants to prevent a tilt of the image or the video image captured in the virtual space when tilting the real camera, this function can be dealt with by adding a function of selecting whether to link a tilt of the virtual camera with a tilt of the real camera. FIG. 9 illustrates a flow of selecting whether to link a tilt of the real camera and a tilt of the virtual camera.

A video image tilt fixation button is assigned to the assignable button 403 or the like and functions to allow the user to notify the camera of an intention to move the virtual camera by tilting the real camera. When the video image tilt fixation button is pressed (YES in step S901), the processing proceeds to step S902. In step S902, the tilt of the video image is fixed. Then, in step S903, the movement of the camera position illustrated in FIG. 8 is started. When the user stops pressing the camera movement button (NO in step S901), the processing proceeds to step S904. In step S904, the fixation of the tilt of the video image is released.

Normally, the tilt of the real camera detected by the gyroscope or the like is transmitted from the real camera to the virtual space imaging unit 105. The virtual space imaging unit 105 calculates angle information of the virtual camera based on the transmitted tilt information. The angle information may be calculated by directly setting the tilt of the real camera as an absolute tilt in the virtual space, or may be calculated by a relative method of adding a change in the angle to the current tilt. The calculated angle information is transmitted from the virtual space imaging unit 105 to the virtual space video image generation unit 106. The virtual space video image generation unit 106 then displays the virtual camera based on the angle information. A change in the angle of the virtual camera is also accompanied by a change in the video image captured by the virtual camera in the virtual space.

When fixing the tilt of the video image in step S902, the virtual space video image generation unit 106 stops updating information about a pitch and a roll. Then, even when the camera is tilted for a forward, backward, leftward, or rightward movement, the tilt of the virtual camera is not changed, and the tilt of the video image does not change anymore. The virtual space video image generation unit 106 may reflect the tilt only for the display of the virtual camera in the virtual space, and stop updating the tilt information of the camera when generating the video image to stop only a change in the tilt of the video image.

When releasing the fixation of the tilt of the video image in step S904, the virtual space video image generation unit 106 can release the fixation just by restarting the update. In a case where the angle information of the virtual camera is calculated using the absolute method, the video image is switched from the video image at the angle when the tilt of the video image is fixed to a video image at an angle at the moment when the user stops pressing the button (step S901). In a case where the angle information of the virtual camera is calculated using the relative method, the angle of the video image is changed according to a change in the tilt since when the user stops pressing the button (step S901).

In this manner, performing the method indicated in the present embodiment allows the user to move the positions of the avatar and the virtual camera by tilting the real camera, thereby contributing to reducing cumbersomeness of a button operation and the like.

The present disclosure has been described in detail based on typical embodiments thereof, however, the present disclosure is not limited to these specific embodiments, and also covers various embodiments within a range that does not depart from the spirit of the present disclosure. The above-described embodiments may be partially combined as necessary.

According to the above-described embodiments, the user becomes able to perform an operation specific to the virtual space easily and simply when capturing an image in the virtual space.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2025-064311, filed Apr. 9, 2025, which is hereby incorporated by reference herein in its entirety.

What is claimed is:

1. An imaging apparatus comprising:
an image sensor that captures an image of a subject;
a memory storing instructions; and
one or more processors that, upon execution of the stored instructions, configure the one or more processors to:
receive an instruction from a user regarding imaging in a virtual space, and
transmit the instruction from the user regarding the imaging by the imaging apparatus in the virtual space to an image generation unit configured to generate an image of the virtual space and output an image captured in the virtual space to a display.

2. The imaging apparatus according to claim 1, wherein the instruction from the user regarding the imaging in the virtual space includes information regarding any one or more of an operation of changing a position of the imaging apparatus in the virtual space, an operation of changing a position and a range on which the virtual space is displayed, an operation of making a selection in a menu display of the virtual space, and an operation of moving a pointer in the virtual space.

3. The imaging apparatus according to claim 1, wherein the instruction from the user regarding the imaging in the virtual space includes information about at least one or more of an operation of an operation member of the imaging apparatus or a tilt of the imaging apparatus.

4. The imaging apparatus according to claim 3, wherein, when the information about the tilt of the imaging apparatus is used for an operation in the virtual space, a tilt of the image captured in the virtual space is not changed.

5. A method for controlling an imaging apparatus configured to image a subject, the method comprising:
receiving an instruction from a user regarding imaging in a virtual space; and
transmitting the instruction from the user regarding the imaging by the imaging apparatus in the virtual space to an image generation unit configured to generate an image of the virtual space and output an image captured in the virtual space to a display.

6. A non-transitory computer-readable storage medium storing a program that when executed by a computer causes the computer to perform the control method for controlling an imaging apparatus configured to image a subject, the control method comprising:
receiving an instruction from a user regarding imaging in a virtual space; and
transmitting the instruction from the user regarding the imaging by the imaging apparatus in the virtual space to an image generation unit configured to generate an image of the virtual space and output an image captured in the virtual space to a display.

7. An image generation unit comprising:
a memory storing instructions; and
one or more processors that, upon execution of the stored instructions, configure the one or more processors to:
generate an image of a virtual space,
output an image captured in the virtual space to a display,
receive, from an imaging apparatus configured to image a subject, an instruction from a user regarding imaging by the imaging apparatus in the virtual space, and
perform processing in the virtual space based on the received instruction.

8. The image generation unit according to claim 7, wherein the instruction from the user regarding the imaging in the virtual space is information regarding any one or more of an operation of changing a position of the imaging apparatus in the virtual space, an operation of changing a position and a range on which the virtual space is displayed, an operation of making a selection in a menu display of the virtual space, and an operation of moving a pointer in the virtual space.

9. The image generation unit according to claim 7, wherein the instruction from the user regarding the imaging in the virtual space is information about at least one or more of an operation of an operation member of the imaging apparatus or a tilt of the imaging apparatus.

10. The image generation unit according to claim 9, wherein, when the information about the tilt of the imaging apparatus is used for an operation in the virtual space, a tilt of the image captured in the virtual space is not changed.

11. A control method comprising:
generating an image of a virtual space;
outputting an image captured in the virtual space to a display;
receiving, from an imaging apparatus configured to image a subject, an instruction from a user regarding imaging by the imaging apparatus in the virtual space; and
performing control of processing in the virtual space based on the received instruction.

12. A non-transitory computer-readable storage medium storing a program that upon execution causes a computer to execute the control method according to claim 11.

13. A system for image processing comprising:
an imaging apparatus; and
an image generation unit configured to acquire an instruction from a user regarding imaging by the imaging apparatus in a virtual space,
wherein the imaging apparatus includes
an image sensor configured to image a subject,
a memory storing instructions, and
one or more processors that, upon execution of the stored instructions, configure the one or more processors to:
receive the instruction from the user regarding the imaging in the virtual space, and
transmit the instruction from the user regarding the imaging by the imaging apparatus in the virtual space to the image generation unit configured to generate an image of the virtual space and output an image captured in the virtual space to a display, and
wherein the image generation unit includes
a memory storing instructions, and
one or more processors that, upon execution of the stored instructions, configure the one or more processors to:
generate the image of the virtual space,
output the image captured in the virtual space to the display,
receive, from the imaging apparatus configured to image the subject, the instruction from the user regarding the imaging by this imaging apparatus in the virtual space, and
perform processing in the virtual space based on the received instruction.

14. The system for image processing according to claim 13, wherein the instruction from the user regarding the imaging in the virtual space is information regarding any one or more of an operation of changing a position of the imaging apparatus in the virtual space, an operation of changing a position and a range on which the virtual space is displayed, an operation of making a selection in a menu display of the virtual space, and an operation of moving a pointer in the virtual space.

15. The system for image processing according to claim 13, wherein the instruction from the user regarding the imaging in the virtual space is information about at least one of an operation of an operation member of the imaging apparatus or a tilt of the imaging apparatus.

16. The system for image processing according to claim 15, wherein, when the information about the tilt of the imaging apparatus is used for an operation in the virtual space, a tilt of the image captured in the virtual space is not changed.
